(19) United States
(12) Patent Application Publication
(10) Pub. No.: US 2021/0016753 A1
(43) Pub. Date: Jan. 21, 2021

(54) BRAKE SYSTEM FOR A VEHICLE, COMPRISING AN AT LEAST PARTIALLY AUTOMATED CONTROL FUNCTION

(71) Applicant: Volkswagen Aktiengesellschaft, Wolfsburg (DE)

(72) Inventor: Stefan Schröder, Braunschweig (DE)

(21) Appl. No.: 17/042,864

(22) PCT Filed: Mar. 11, 2019
(86) PCT No.: PCT/EP2019/055984

§ 371 Date: Sep. 28, 2020

(30) Foreign Application Priority Data
Mar. 29, 2018 (DE) 10 2018 204 900.9

(51) Int. Cl. B60T 13/14; B60T 13/68

(52) U.S. Cl. CPC B60T 13/145; B60T 13/686

(57) ABSTRACT

The present disclosure relates to a brake system for a vehicle, having an at least partially automated control function. The brake system comprises a brake pedal to be mechanically actuated by a driver for a brake request and a hydraulic transmission system for conducting a transmission medium which transmits the actuation of the brake pedal by the driver to a wheel brake. For this purpose, the transmission system has an accumulator for the transmission medium in order to temporarily store a displaced volume of the transmission medium upon actuating the brake pedal if the at least partially automated control function is given priority.

### RELATED APPLICATIONS

The present application claims priority to international patent app. no. PCT/EP2019/055984 to Stefan Schroder, filed Mar. 11, 2019, which claims priority to German patent app, no. DE10 2018 204 900.9, filed Mar. 29, 2018, the contents of each being incorporated by reference in their entirety herein.

### BACKGROUND

The present disclosure relates to a brake system for a vehicle that comprises an at least partially automated control function, and has a corresponding brake system. The present disclosure furthermore relates to a method for operating a vehicle that has an at least partially automated control function.

In some vehicles that have an at least partially automated control function, the driver is at least aided in, if not entirely relieved of, controlling the vehicle. Examples of a partially automated control function in a vehicle comprise cruise control, tracking assistance, or adaptive cruise control. Some vehicles also have a highly automated control function in which the driver is relieved of routine tasks, e.g. parking or maneuvering in traffic. Moreover, some vehicles may be equipped with a fully automated control function, in which the driver only needs to control the vehicle in extreme cases. Beyond this, a driverless control function is conceivable with some vehicles. In those vehicles that have an at least partially automated control function, the driver can normally deactivate the at least partially automated control function through mechanical interventions, e.g. braking or steering. On the other hand, purely coincidental or unintentional interventions by the driver in the control of the vehicle, e.g. accidently stepping on the brake pedal, should not deactivate the at least partially automated control function. This could lead to dangerous situations, for example, when the driver may not be prepared to assume control of the vehicle. There is also the danger of the driver's foot jamming when unintentionally stepping on the brake pedal. The brake pedal may also be unintentionally blocked by objects. The interaction between the manual and the at least partially automated control function is therefore in need of improvement.

### BRIEF DESCRIPTION OF THE DRAWINGS

Further measures improving the invention shall be presented below with the description of a preferred exemplary embodiment of the invention in reference to the drawing. Any of the features specified in the claims and in the description may be regarded as substantial to the invention in and of themselves or in arbitrary combinations thereof. It should be noted that the drawing is only for illustrative purposes and is not intended to limit the invention in any way.

Therein:

FIG. 1 shows a schematic illustration of a brake system according to an example.

### DETAILED DESCRIPTION

The present disclosure is directed to a brake system for a vehicle that has an at least partially automated control function, which has a simple and inexpensive construction, and which enables an intuitive and reliable interaction between a manual control function and the at least partially automated control function when operating the vehicle. In some examples, a motor vehicle is disclosed, configured with the corresponding brake system. Various examples illustrate a simple and reliable method for operating a vehicle that has an at least partially automated brake system.

In some examples, a brake system may include a brake pedal for mechanical operation by a driver in the case of an intended braking procedure, and a hydraulic transmission system for conducting a transmission medium, which conveys the actuation of the brake pedal by the driver to a wheel brake. The transmission system may also include a reservoir for transmission fluid for temporarily storing a displaced volume of the transmission medium when the brake pedal is actuated, if the at least partially automated control function has priority.

The brake system according to the present disclosure may be particularly suited for use in a vehicle that has a manual, partially automated, highly automated, fully automated, and/or driverless control function.

The present disclosure acknowledges that in brake systems that have a hydraulic transmission system for conducting a transmission fluid, an active connection between the brake pedal and the wheel brake can never be entirely interrupted, such that an unintentional actuation of the brake pedal can be conveyed to the wheel brake.

In some examples, a reservoir for a displaced volume of the transmission fluid is configured when the brake pedal is actuated, located between the brake pedal and the wheel brake. The reservoir can be used when the at least partially automated control function has priority. The reservoir can also be operated in different modes. In this manner, the reservoir can entirely prevent transmission of the braking force, or reduce it to different extents. When the reservoir is used incrementally, there can be a control valve in the form of a three-way valve, for example. It is also conceivable to place the reservoir in a bypass line, such that it can then only be discharged when the at least partially automated control system has priority. When the vehicle is controlled manually, this bypass line can be closed. When the reservoir is in use, different modes can be implemented, as specified above, depending on the specific control function. The different modes can be activated, switched, or deactivated automatically, e.g. through specific control signals, or manually, e.g. by actuating the brake pedal with a specific force. It is thus conceivable that a certain intervention by the driver for correcting the control of the vehicle can be allowed above a specific threshold for the braking force when actuating the brake pedal, without having to entirely deactivate the at least partially automated control function. At another specific threshold for the braking force, the at least partially automated control function can be shut off, if desired, e.g. when the driver wants to assume full control of the vehicle, or if necessary, e.g. in an emergency, and the driver must assume control of the vehicle. It is also conceivable to switch to different control functions through specific positions of the brake pedal. A hierarchical declination of the degree of automation, when the brake pedal is pressed further down successively, for example, is also conceivable. All of these modes for operating the brake system can be achieved using a choke at the intake and/or discharge for the transmission medium into or out of the reservoir, respectively. When the reservoir is not needed, the entire volume of transmission medium can be returned to the flow path for the transmission fluid.

Furthermore, the reservoir can form a low-pressure reservoir in the brake system under some examples. A low-pressure reservoir is advantageously able to ensure a receiver for the transmission medium that is controlled in a simple manner, e.g. incrementally.

Furthermore, the reservoir in the brake system disclosed herein can also have a control valve. The control valve forms a choke for the intake and discharge of the transmission medium into or out of the reservoir. This control valve can be a three-way valve. The reservoir can be connected to or disconnected from the flow path for the transmission medium in a simple manner using a three-way valve. In one setting, the three-way valve can simply bypass the reservoir.

The reservoir in a brake system under the present disclosure can also contain a release mechanism that releases a temporarily stored volume of the transmission medium in an emergency situation, in particular if the at least partially automated control function of the vehicle is unaware of it, if the force the driver applies to the brake pedal exceeds an emergency threshold, and/or if a crash signal has been issued. It is conceivable to implement the release mechanism in the control valve for this, in order to reduce costs and the number of components in the brake system. It is also conceivable to implement the release mechanism independently of the control valve to obtain a type of overload safeguard, which conducts the entire volume of the transmission medium back into the flow path for the transmission medium in an emergency, such that it is possible to brake the vehicle in tricky situations.

The transmission system in a brake system according to the invention can also have an electomechanical booster device that increases the force with which the driver operates the brake pedal. The booster device can be a simple electromechanical braking force booster. It is advantageously conceivable that the booster device can be activated when a manual control function of the vehicle by the driver has priority, and the booster device can be deactivated when the at least partially automated control function of the vehicle has priority. Without the braking force amplification, any undesired actuation of the brake pedal would be transmitted with less force to the wheel brakes. Further, the brake pedal can also be decoupled from the wheel brake with the use of the reservoir according to the present disclosure.

Furthermore, the booster device can have an activation mechanism for activating the booster device in an emergency situation, in particular when it is not noticed by the at least partially automated control function of the vehicle, if the force applied to the brake pedal by the driver exceeds an emergency threshold, and/or a crash signal has been issued. In this manner, the normal manual operation of the brake system can be regained.

Moreover, a control unit for the brake system according to the present disclosure may be in communication with a sensor system in the vehicle to provide a control function with a priority verification, and the at least partially automated control function or a manual control function for the vehicle. The control unit can preferably be a central control unit for the vehicle. As a result, it is possible to execute the method according to the invention described below for operating a vehicle.

Furthermore, a vehicle with a brake system is provided by the present disclosure that can be configured as described herein. The same advantages are obtained with the vehicle according to the invention that are described above in conjunction with the brake system according to the invention. To avoid repetition, reference is made to this description in its entirety.

The present disclosure also provides a method for operating a vehicle when an at least partially automated control function of the vehicle has priority, using a brake system that has a brake pedal for mechanical actuation by a driver during an intended braking procedure, and a hydraulic transmission system for conducting the transmission medium, which conveys the actuation of the brake pedal by the driver to a wheel brake. The method may include the steps of a) checking the control functions of the vehicle to verify priority for a control function, b) deactivating a booster device for the force applied to the brake pedal when an at least partially automated control function of the vehicle is given priority in step a), and c) temporarily storing a displaced volume of the transmission medium when actuating the brake pedal before the transmission medium reaches the wheel brake.

An unintended intervention in the control of the vehicle may be prevented with the method according to the present disclosure in a reliable manner, if the at least partially automated control function of the vehicle is given priority. Furthermore, the same advantages are obtained with the method according to the present disclosure that are described above in conjunction with the brake system according to the invention. To avoid repetition, reference is made to this description in its entirety.

In some examples, the method set forth in the present disclosure may also include at least one further step, namely, d) choking the transmission medium when let into a reservoir if the at least partially automated control function for the vehicle is given limited priority, or e) releasing the transmission medium in an emergency situation, in particular if it is not noticed by the at least partially automated control function in the vehicle, if the force applied to the brake pedal by the driver exceeds an emergency threshold, and/or a crash signal has been issued.

Step d) may be advantageous when the driver wants to correct the at least partially automated control function without shutting off the at least partially automated control function. The driver is able to safely intervene in the control of the vehicle through step e).

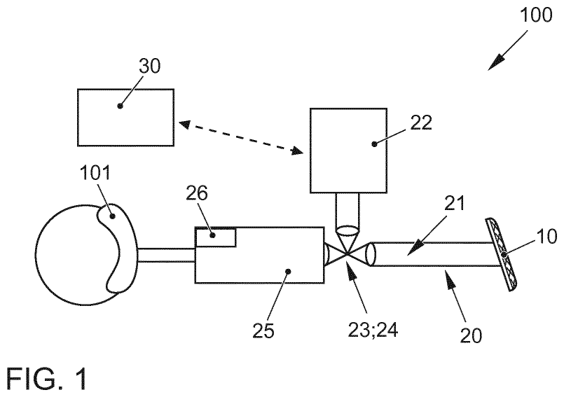

FIG. 1 shows a brake system 100 for a vehicle as set forth under one example, wherein the vehicle contains an at least partially automated control function. Possible control functions for the vehicle are a purely manual, a partially automated, a highly automated, a fully automated, and an autonomous or driverless control.

The brake system 100 may include a moving brake pedal 10 that is actuated by a movement of a driver's foot in the normal operation of a manual control function. A hydraulic transmission system 20 leads from the brake pedal, which conducts a transmission medium 21, e.g. brake fluid. The transmission medium 21 conveys the braking force to the wheel brake 101 when the brake pedal 10 is operated by the driver. A reservoir 22 for the transmission medium 21 is provided in the framework of the transmission system 20 according to the invention for temporarily storing a displaced volume of the transmission medium 21 when the brake pedal is operated, if the at least partially automated control function is given priority.

The reservoir 22 advantageously decouples the functional connection between the brake pedal 10 and the wheel brakes 101 in a hydraulic transmission system 20. An unintended actuation of the brake pedal 10 can advantageously be intercepted by the reservoir 22, such that the wheel brakes 101 are not accidently actuated during at least partially automated driving.

The reservoir 22 is interconnected, according to one example, between the brake pedal 10 and the wheel brakes 101. The reservoir 22 can then be used in particular in an advantageous manner when the at least partially automated control function is given priority over a manual control function or another at least partially automated control function.

The reservoir 22 can be used in different modes in the framework of the present disclosure. The reservoir 22 can thus entirely prevent conveyance of the braking forces, in that it receives the entire displaced volume of transmission medium 21, or it can reduce the braking force in different increments when only a portion of the displaced volume of transmission medium 21 is received or choked. A control valve 23 can be provided for a graded or incremental use of the reservoir 22, e.g. in the form of a three-way valve. The control valve 23 can release the reservoir 22 when the at least partially automated control function has priority. In the case of manual control of the vehicle, the control valve 23 can enable an unimpeded flow of the transmission medium 21 that bypasses the reservoir 22.

When the reservoir 22 is used, different modes can be implemented based on the determined control function. The different modes can be activated, switched and deactivated automatically, e.g. when specific control signals have been issued, e.g. by a control unit 30, or manually, e.g. by the driver when operating the brake pedal 10. It is thus conceivable that, starting from a specific threshold for the braking force when the driver operates the brake pedal 10, a certain intervention by the driver in controlling the vehicle can be allowed for correcting the control, even if only slightly, without entirely deactivating the at least partially automated control function. At a further determined threshold for the braking force, the at least partially automated control function can be shut off. These situations are conceivable when the driver wants to assume control of the vehicle, or must do so in an emergency. It is also conceivable for it to be possible to switch between different partially automated control functions through different positions of the brake pedal 10. A hierarchical declination of the degree of automation, for example, is conceivable.

Different modes for operating the brake system 100 according to the present disclosure can be obtained with a choke at the intake and/or discharge for the transmission medium 21 into our out of the reservoir 22. If the reservoir 22 is not needed, for example, during a manual control function of the vehicle, the entire volume of the transmission medium 21 can be returned to the flow path for the transmission medium 21.

The reservoir can also contain a release mechanism 24, in order to release a temporarily stored volume of the transmission medium 21 in an emergency situation. An emergency situation can be detected, for example, when the force applied to the brake pedal 10 by the driver exceeds an emergency threshold, and/or when a crash signal has been issued, e.g. by a control unit 30.

Furthermore, there can be an electromechanical booster device 25 in the transmission system 20, that amplifies the force with which the driver actuates the brake pedal 10 in a manual control function. The booster device 25 can advantageously be deactivated if the at least partially automated control function for the vehicle has been given priority. The booster device 25 can likewise contain an activation mechanism 26 that allows it to be activated in an emergency situation.

As a result, it can be advantageously ensured in an emergency situation that the driver is in control of the brake system 100.

The control unit 30 can be formed as, for example, a central control unit 30 for the vehicle.

The above description of the drawing describes the present disclosure in the framework of an example. As a matter of course, individual features of the embodiments can be freely combined with one another without abandoning the scope of the present disclosure, as long as this is technically feasible.

### LIST OF REFERENCE SYMBOLS

100 brake system

10 brake pedal

20 transmission system

21 transmission medium

22 reservoir

23 control valve

24 release mechanism

25 booster device

26 activation mechanism

30 control unit

1-10. (canceled)

11. A brake system for a vehicle including an at least partially automated control function, comprising:
a brake apparatus for mechanical operation during an intended braking procedure; and
a hydraulic transmission system for conducting a transmission medium based on the actuation of the brake apparatus,
wherein the transmission system comprises a reservoir for temporarily storing a displaced volume of the transmission medium when the brake apparatus is actuated, and if the at least partially automated control function has been given priority by the vehicle over the mechanical operation.

12. The brake system according to claim 11, wherein the reservoir comprises a low-pressure reservoir.

13. The brake system according to claim 11, wherein the reservoir comprises a control valve.

14. The brake system according to claim 13, wherein the control valve comprises a three-way valve.

15. The brake system according to claim 11, wherein the reservoir comprises a release mechanism for releasing a temporarily stored volume of the transmission medium (i) if a force with which the driver actuates the brake apparatus exceeds a threshold, and/or (ii) if a crash signal has been issued by the vehicle.

16. The brake system according to claim 11, wherein the transmission system comprises an electromechanical booster device for amplifying a force with which the brake apparatus is actuated.

17. The brake system according to claim 16, wherein the booster device is configured to activate if a manual control of the vehicle by the driver is given priority by the vehicle, and wherein the booster device is configured to be deactivated if the at least the partially automated control function of the vehicle is given priority.

18. The brake system according to claim 16, wherein the booster device comprises an activation mechanism for activating the booster device (i) if a force with which the driver actuates the brake apparatus exceeds a threshold, and/or (ii) if a crash signal has been issued by the vehicle.

19. The brake system according to claim 11, further comprising a control device configured to communicate with a sensor system for verifying a priority of a control function.

20. The brake system according to claim 19, wherein the control device is configured to provide (i) the at least partially automated control function, or (ii) a manual control function for the vehicle.

21. A method for operating a vehicle configured to execute an at least partially automated control function, comprising:
assigning, via a control device, a priority to one of (i) the at least partially automated control function, or (ii) a mechanical operation;
detecting, via one or more sensors, force applied to a brake device;
deactivating a booster device, operationally coupled to the brake device, when the force is applied to the brake device is detected and the at least partially automated control function is assigned the priority; and
temporarily storing a displaced volume of transmission medium in a reservoir of a hydraulic transmission system before the transmission medium reaches the brake device.

22. The method according to claim 21, wherein assigning the priority to the at least partially automated control function comprises assigning a limited priority.

23. The method according to claim 22, further comprising choking the transmission medium when temporarily storing the displaced volume of transmission medium if the at least partially automated control function for the vehicle is assigned limited priority.

24. The method of claim 21, further comprising releasing the transmission medium (i) if the detected force applied to the brake device exceeds a threshold, and/or (ii) a crash signal has been issued by the vehicle.

25. The method according to claim 21, wherein the reservoir comprises a low-pressure reservoir.

26. The method according to claim 21, wherein the reservoir comprises a control valve.

27. The method according to claim 26, wherein the control valve comprises a three-way valve.

28. A brake system for a vehicle including an at least partially automated control function, comprising:
a control device, configured to assign a priority to one of (i) the at least partially automated control function, or (ii) a mechanical operation;
a brake apparatus for mechanical operation by a drive during an intended braking procedure; and
a hydraulic transmission system comprising a reservoir, wherein the hydraulic transmission system is configured to conduct a transmission medium based on the actuation of the brake apparatus, and wherein the hydraulic transmission system is configured to temporarily store a displaced volume of the transmission medium when the brake apparatus is actuated, and if the at least partially automated control function has been assigned priority by the control device over the mechanical operation.

29. The brake system according to claim 28, wherein the reservoir comprises a low-pressure reservoir.

30. The brake system according to claim 28, wherein the reservoir comprises a control valve.

31. The brake system according to claim 30, wherein the control valve comprises a three-way valve.
